(19) United States
(12) Patent Application Publication
(10) Pub. No.: US 2012/0042165 A1
(43) Pub. Date: Feb. 16, 2012

(54) METHOD FOR PROVIDING DATA ON MOBILE TERMINALS AND MOBILE TERMINAL FOR PERFORMING THE METHOD

(76) Inventor: Georg Wittenburg, Berlin (DE)

(21) Appl. No.: 13/264,706

(22) PCT Filed: Apr. 16, 2010
(86) PCT No.: PCT/EP10/55058

§ 371 Date: Oct. 26, 2011

(30) Foreign Application Priority Data
Apr. 16, 2009 (DE) 10 2009 017 315.3

(51) Int. Cl. G06F 15/16; H04L 9/32

(52) U.S. Cl. 713/168; 709/217

(57) ABSTRACT

A method for providing data on mobile terminals is provided. The method comprising the following steps: providing a continuous network connectivity of the plurality of mobile terminals of different users executing a local application on one of the terminals, which leads to a creation or a change of a data set and automatically providing the created or changed data set on the other terminals. The created or changed data set is automatically provided on the other terminals in that the created or changed data set is transmitted to the other terminals by means of a push service and the created or changed data set is transparently integrated into the corresponding local application on the other terminals.

### CROSS-REFERENCE TO A RELATED APPLICATION

This application is a National Phase Patent Application of International Patent Application Number PCT/EP2010/055058, filed on Apr. 16, 2010, which claims priority of German Patent Application Number 10 2009 017 315.3, filed on Apr. 16, 2009.

### BACKGROUND

The invention relates to a method for providing data on mobile terminals and a mobile terminal for performing such a method.

Mobile terminals such as mobile phones, personal digital assistance (PDAs) or notebook computers have developed in the last years to user friendly and versatile communication and multi-media platforms. The trend towards mobile “always on” devices, which have a steady data connection to the Internet under the keyword “mobile phone flat rate”, is going to increase due to the market development in the mobile communication area and the spreading of WiFi-hotspots and areas.

At the same time a tendency to a collaboratively processing, evaluation and distribution of data has been established in the Internet due to the technical development known “web 2.0 revolution”. In the present variants of the web 2.0 services for mobile terminals, a typical advantage of these services—namely the collaboration between the users—is not or only to a certain degree implemented. The potential, which these services have exactly as applications in mobile terminals due to the continuous access possibility by the user to these devices and the strong personal connection to these devices, is not or only rudimentary used.

### SUMMARY

The object of the present invention is to provide a method and a device for providing data, which integrate smoothly into the use habits of mobile terminals and support simultaneously the interaction and collaboration known from the web 2.0.

According to an exemplary embodiment of the invention it is provided that a data set created or changed, when executing a local application on a mobile terminal, is automatically provided to other terminals of other users by transmitting the created or changed data set by means of a PUSH service to the other terminals and a created or changed data set is transparently integrated in the other terminals into the corresponding local application.

The wording according to which the data set of a mobile terminal is “transparently integrated” into the local application of another terminal means in particular that the created or changed data set of the one terminal occurs by updating a corresponding data set of the local application of the other terminal, wherein the update concurs for instance by informing the user.

The idea of the present invention is thus the transparent integration of changed or newly created data set of a mobile terminal into an existing application of at least one further mobile terminal of another user, wherein an automatic data synchronisation occurs. The data set looked at can for instance relate to pictures, videos, office documents, contact information, and address information or personal status information.

The method for collaboratively providing data on mobile terminals integrates transparently the applications working locally on the singular terminals to a service working in a distributive manner, which automatically updates the processed data on other authorised terminals. A change of the personal data by the owner in the user profile on a device results for instance in an automatic update of the corresponding data set on all other authorised terminals of other users in a timely manner. Thus, in this case, present contact information is not longer only available indirectly via profile sites between the users in corresponding directory services, but directly in the address book of the mobile terminals. In analogy services for instance for appointments, multi-media elements or status information are conceivable.

“Status information” are deduced for instance from the status of the terminal, the interaction of the user with the terminal or also from the circumstances of the location (that means the environment) in which the terminal is. Status information which are deduced from the status of the terminal, relate for instance to the state of charge of the battery or the available memory. Status information, which are deduced from the interaction of the user with the terminal, contain for instance information about if the terminal is switched on, which ring tone is set up and/or if the user talks at the moment. Status information, which results from the circumstances of the location of the terminal, can for instance comprise the position of the terminal.

The described method expands locally performing applications via connection to a distributed working, linked component. This connection between application and network component in a quality being sufficient for providing a service is possible by emerging of continuous network connectivity (“always on”, i.e. a continuous connection to a communication network). The local application can be basically each program, which provides new or changed data sets. That are for instance standard applications of mobile terminals such as address book, appointment calendar, user profile (in case of mobile telephones usually implemented as a special case in the address book), note pad, photo album, multimedia applications or general status determining information of the terminal.

The network component is constructed on fundamental paradigms such as the client/server architecture or alternatively a peer-to-peer architecture. The decision, which of these alternatives should be used when realising the method, can be made under consideration of the business model of the provider; a client/server architecture allows a payment model on the basis of subscriptions or payments per data exchange, requires accordingly however investments into the server infrastructure. In case of a peer-to-peer architecture the investment becomes no longer necessary; however, a user related payment is not any longer directly possible. These two approaches can however be combined by dividing the application portfolio into free application (for instance status notifications or pictures) or surplus value application (for instances for addresses or appointments), wherein the first one can be processed via the peer-to-peer architecture and the latter one via the client/server architecture. Thus, only infrastructure costs come up only for surplus value applications, while simultaneously a larger user circle can be made accessible via the free applications.

The present invention comprises furthermore the conduct of an authentification, which determines which data set are transmitted to which users and terminals. For this reason, the data sets to be distributed are for instance identified via a code number, wherein a code number designates in each case a data set in its temporarily changeable form. That the data set has “a temporarily changeable form” means in particular that this data set is a dynamic object which can be changed at any time by the system (the network and the terminals). Such changeable data sets can be designated for their distinct identification for instance with a non-changeable name, an identification number or an address.

A code number designates for instance an entry into the address book of a user. Equally, the singular users can also be identified via code numbers. Thereby, it is furthermore possible to combine multiple users locally to user groups by a corresponding entry possibility.

An authentification component regulates the axis of users or groups to the data sets. The implementation can be done in case of a client/server architecture in form of a centrally stored access control lists (access control lists—ACL). When implementing a peer-to-peer architecture, an authentification between the users occurs in each case immediately due to the distributed storage of the data on terminals of a third person. This will usually require an additional encoding of the data sets. The key exchange can be part of the initial authentification step between two users in this case.

A user recognition is for instance assigned in each case to the users of a peer-to-peer network and the encoding of the data sets occurs by using a key pair associated to the respective user recognition, which comprises in each case a private and a public key. The user recognition contains in particular a user name, can however, also contain further information, for instance a hardware recognition of the mobile device used by the user, date and/or random data (for instance a random data stream) in order to produce a distinct user recognition.

Furthermore, each user can sign the user recognition with its own (in particular locally generated) private key for its identification in order to produce an identification data set. This identification data set is in particular deposited in the Hash-value of the user recognition in the peer-to-peer network (for instance on the mobile terminal of the user).

The identification data set comprises besides the user recognition for instance additional status information (for instance relating to the activity of the user in order to announce if the user is or is not logged into the network) and/or the present address (in the underlying network of the peer-to-peer network) of the mobile terminal used by the user in order to carry out a direct communication process. Furthermore, the one and the same identification data set can be also deposited multiple times in the peer-to-peer network, in particular in order to avoid or at least to elevate a non-desired deletion of an identification data set from the peer-to-peer network by unauthorized persons.

Users of the peer-to-peer network, which have the public key, which is assigned to the private key of the user of the identification data set deposited in the network, can retrieve the identification data set, can verify its signature by means of the public key and can obtain access to the information of the information data set. Furthermore, the users having access to the identification data set, can deposit for their part an identification data set in the Hash-value of their user recognition in the peer-to-peer network if the have not already done this before.

The identification data sets of the users of the peer-to-peer network provided by the users of the peer-to-peer network can furthermore contain an expiration date, from which on the respective identification data set should be invalid in order to keep the network as free as possible from outdated identification data sets.

According to an exemplary variant of the method according to the invention for distributed storage of the newly created or changed data set
the created or changed data set is encoded with its own symmetrical key,
the symmetrical key is encoded by the public key of the user, which shall receive the data set, and
the encoded data set is deposited together with the encoded symmetrical key in the peer-to-peer network.

The symmetrical key is in particular encoded by the public keys of multiple users in order to allow access to the data set for multiple users. The encoded data set is for instance deposited together with the encoded symmetrical key in the Hash-value of its code number in the peer-to-peer network, wherein the code number of the data set contains in particular the user recognition of the user of the data set. The code number can however contain beside the user recognition of the user, further information (for instance a distinct name) in order to create distinct data set recognitions. It is furthermore conceivable that the owner of the data set signs the data set and/or the user recognition (or its Hash-value) by means of its private key.

In a further exemplary embodiment it is provided that the integration of a changed data set into an application of the user of the mobile terminal, which contains the data set, is displayed. For instance, an optical display occurs for instance in form of a short message and/or an acoustic display. Such a display does not mean that the received data set would not be automatically integrated into the corresponding local application. Only the fact of the occurred update of the data set is displayed.

A further exemplary embodiment provides that a created or changed data set is being again changed by the application of a mobile terminal, which receives the data set, and an again changed data set is sent back via a push service to the mobile terminal, which has previously created or changed the data set, and is again integrated into the application of this terminal. Thus, a type of ping-pong update occurs. A possible application for this is a note pad, for instance a shopping list, which is continuously updated between two (or also multiple) terminals.

The invention relates furthermore to a mobile terminal, which has a continuous connectivity to a communication network. The mobile terminal comprises: At least one local application and means for executing the local application, which provides a creation or a change of a data set, a service adapter assigned to the application and authentification component, in which access rights to the created or changed data sets are deposited. Thereby the service adapter is designed and configured such a) to provide the user of a mobile terminal by using the authentification component the possibility to grant other users of mobile terminal access rights to the created or changed data sets and b) to transmit a created or changed data set by means of a PUSH service automatically to a terminal of other users. The PUSH service distributes then the data sets under consideration of the data sets being deposited in the authentification component, wherein the created or changed data set is transparently integrated in the terminals of the other users into the corresponding local application. The mobile terminal comprises furthermore means, which, when receiving a created or changed data set of another terminal transparently, integrate the created or change data set into the corresponding own application.

The latter mentioned means allow that the terminal does not only transparently passes data sets being created by it or updated to other terminals, but also transparently integrates data sets created or updated by other terminals into their own corresponding applications. The integration of a received, updated data set into an application occurs thereby preferably by the service adapter, i.e. the PUSH service transmits a received date to the corresponding service adapter, which then takes care of the update of the data in the application.

The PUSH service superimposes for instance on the application interface of the operating system of the device or device platform. Also the application itself and the authentification component superimpose for instance on the application interface of the operating system of the device or the device platform.

The authentification component is in particular designed in order to provide an identification data set as described above and to allow the also above described encoding of the data set to be distributed, i.e. said authentification component comprises corresponding identification data set generating means and encoding means.

### BRIEF DESCRIPTION OF THE DRAWINGS

The invention is subsequently described by reference to the figures of the drawing by means of multiple examples in more detail.

FIG. 1 shows a flow chart of method steps of an embodiment of a method according to the invention for providing data on mobile terminals.

FIG. 2 shows an embodiment of a system architecture for realising the present invention.

FIG. 3 shows a flow chart of the method steps, which are provided by the components of the system in FIG. 2.

FIG. 4 shows schematically a client/server architecture.

FIG. 5 shows schematically a peer-to-peer architecture.

### DETAILED DESCRIPTION

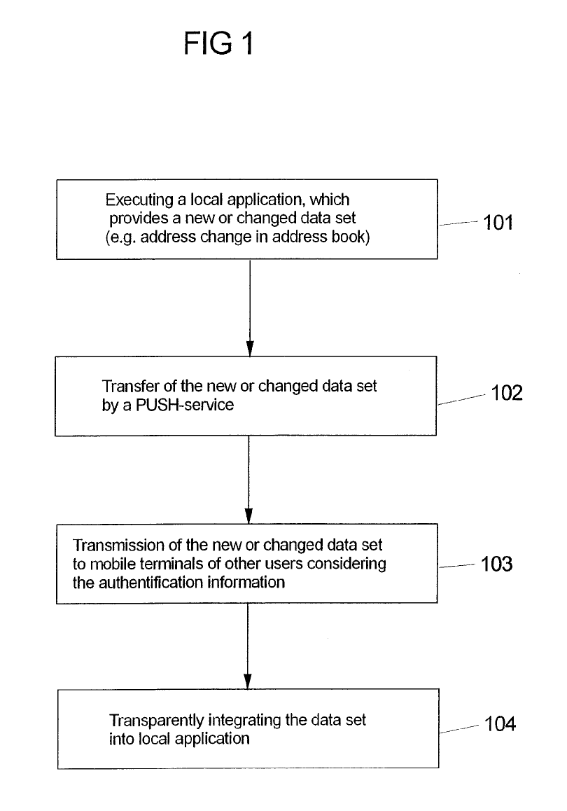

FIG. 1 shows a flow chart of the method steps of an embodiment of the method according to the invention for collaboratively providing data on mobile terminals. “Collaboratively” means thereby that at least two mobile terminals are part of the method.

The mobile terminals looked at are provided with a continuous network connectivity (also designated as “always on”), thus have permanent access to a communication network, wherein the communication network can consist of a multiple of different, circuit-switched and/or package-switched communication networks being coupled to each other including radio networks. For instance, continuous network connectivity consists to the telecommunication network of a telecommunication provider and/or the Internet.

A local application is being carried out in one of the mobile terminals according to step 101 of FIG. 1. This provides a new or changed data set. The local application can be for instance an address book application. The execution of the application relates for instance to the entry and storage of the changed address into the address book of the user of the mobile terminal. The mobile terminal is for instance a mobile telephone, a laptop, a PDA or such.

In a further method step 102, the new or change data set is passed over to a PUSH service. This occurs automatically in the background without that the user of the terminal would initiate this by the entry of a command. In the example of an address change in the address book of the user looked at for instance a changed data set, which contains the updated data of the address book (or alternatively only the change), is thereby passed over to the PUSH service.

In step 103 the new or changed data set is transmitted to the other mobile terminals. This occurs under consideration of the authentification information, which is provided when passing the data to the PUSH service or were provided in a previous step to the PUSH service. This authentification information determines which user shall have access to which data in the network.

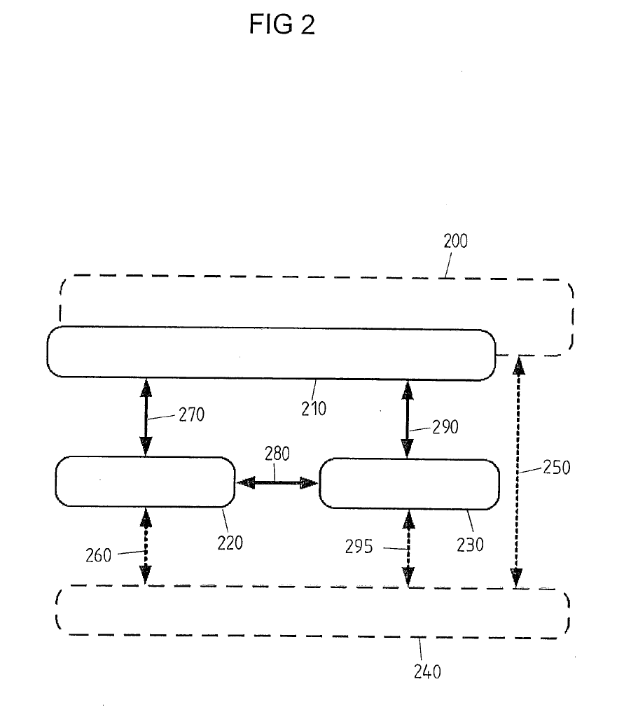

The transmitted data set is transparently integrated in step 104 that means in the background and without that the user of terminal who receives the data set has to initiate it into the corresponding local application of the user of said mobile terminal. The corresponding application is the application, which is also executed in the terminal, which has created or changed the data set, thus an address book application in the embodiment looked at. The changed address of step 101 is thus transparently integrated into the address book of the user, which has received the changed data set. The integration is thereby no new own application but rather occurs into a application of the mobile terminal being already present. Thereby the PUSH service superimposes for instance onto the application interface of the operating system of the mobile terminal and uses for instance a service adapter of the target application for updating the data. Such a service adapter is explained in more detail in FIG. 2.

FIG. 2 shows an exemplary system architecture by means of which the invention can be realised. The system architecture comprises a service adapter 210, an authentification component 220 and a PUSH service 230.

The service adapter 210 is assigned to an application 200. It is for instance a standard application of a mobile terminal such as an address book application or appointment book calendar application. Thereby the application superimposes as indicated by the error 250 onto the application interface of the operating system 240 of the mobile terminal.

The service adapter 210 adapts device or platform specific applications or develops new applications based thereon so that they can transparently interact with the authentification component 220 and the PUSH server 230 for the user within the local data processing. Thereby the data processed such are distributed on the one hand via the PUSH service 230 within the network. On the other hand, it is determined via the authentification, which user in the network should have access to which data. The service adapter 210 provides thus the application integration of the described method.

Furthermore, the service adapter 210 provides a user the possibility via an expansion of the user interface of the application 200 and when using the authentification component, to grant other users access rights to the data sets ordered by him.

The authentification component 220 assigns code numbers to the data sets to be distributed. The code number characterizes thereby a concrete data set in its temporarily changeable form. That code number thus allows a temporarily component. Furthermore, it can also be provided that users of terminals, which should have access to certain data sets, are identified via code numbers. Thereby, also multiple users can be locally combined via two user groups by a corresponding entry possibility.

The code number is the key, which is based on a character set being readable for the user, for instance alphanumerical characters. A distribution of the updated data set can occur in a simple manner via the code number.

The authentification component 220 controls now the access of users or groups of users to data sets. The implementation can occur in case of a client/server architecture in form of centrally stored access control lists. When implementing as peer-to-peer architecture an additional encoding is required due to the distributed storage of the data on terminals of third persons. The key exchange becomes in this case part of the initial identification step between two users.

The authenfication component 3 superimposes as indicated by arrow 260 as well on the application interface of the operating system 240 of the mobile terminal. Said component communicates with the service adapter 210 and the PUSH service 230 (compares arrows 270, 280).

The PUSH service updates the data sets created and changed by the user of the mobile terminal via the application 200 in a timely manner on mobile terminals of other users, in so far the corresponding access rights, which are deposited in the authentification component 3, are provided. The PUSH service 230 communicates insofar with the authentification component 220 and the service adapter 210 as indicated by the arrows 280 and 290. The service adapter 210 distributes thereby the data sets processed or created by the user via the application by means of the PUSH service to the terminals of other users.

PUSH services are known to persons skilled in the art so that the specific modification does not have to be addressed further.

The PUSH service 230 superimposes as well as the application 200 and the authentification component 220 onto the application interface of the operating system 240 of the mobile terminal, here onto the application interface of the operating system of the device, which receives the created or updated data by means of the PUSH service. Said service uses thereby the service adapter of the target application for updating the data. For the purpose of the simplified portability of the method a software abstraction layer can be inserted. The superimposing of the PUSH service onto the application interface of the operating system allows a transparent integration of the data set taking place in the background into the corresponding local application of the terminal, which has received the new or changed data set.

If a mobile terminal is not accessible at the time point of updating, then the update takes place at the next possible time.

The implementation of the PUSH service can occur in case of a client/server architecture via data sets being deposited on a server or via data sets being identified via their code number. In case of a peer-to-peer architecture, the data sets can be distributed via a distributed Hash-table (VHT) and can be stored redundantly on multiple terminals of third persons. A distributed Hash-table is a data structure which allows distributing data objects possibly even via the quantity of knots of a peer-to-peer network. Distributed Hash-tables are thereby known so that they do not have to be addressed further.

It can be provided that for each application 200 of the terminal a separated service adapter 210 is provided. The service adapter 210 is thus in each case specific for an application or service. It can be furthermore provided that the different service adapters 210 fall back to the same PUSH service 210.

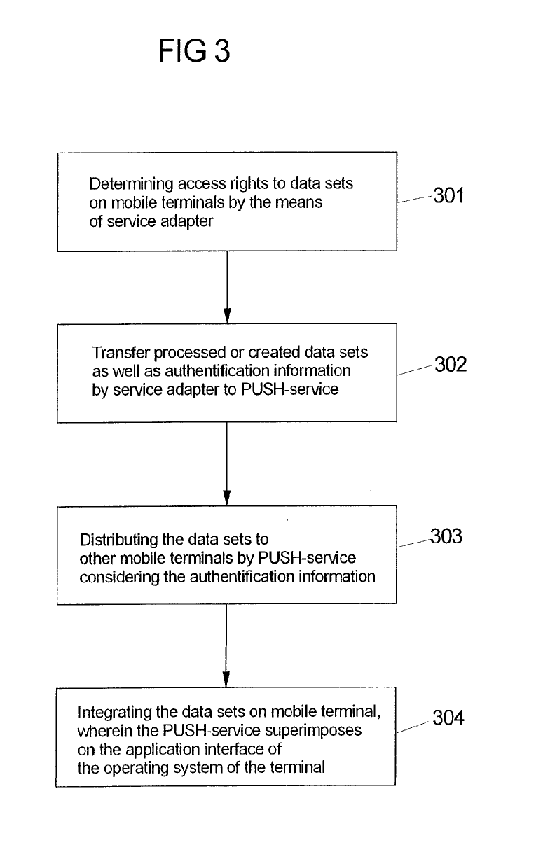

FIG. 3 explains the steps executed by the system component of the FIG. 2.

In step 301 access rights to data sets on a mobile terminal are determined by means of the service adapter 210. This occurs for instance via an expansion in the user interface of the application, which is provided by the service adapter 210. Thereby, the data sets and the users, which are to receive them, can be thereby designated via code numbers.

In step 302 one or multiple processed or created data sets as well authentification information are passed by the service adapter to a PUSH service. According to step 303 the PUSH service distributes the one or the data sets to the other mobile terminals under consideration of the authentification information. The authentification information could thereby be passed effectively via the service adapter to the PUSH service. It is however also possible that these have already been passed in a previous step to the PUSH service or a service of the network so that the PUSH service can fall back then to these already previously being passed information for authentification.

In step 304 an integration of the data sets transmitted via the PUSH service occurs in the corresponding application on the mobile terminal, which has received the one or the data sets, wherein the PUSH service superimposes on the application interface of the operating system of the terminal.

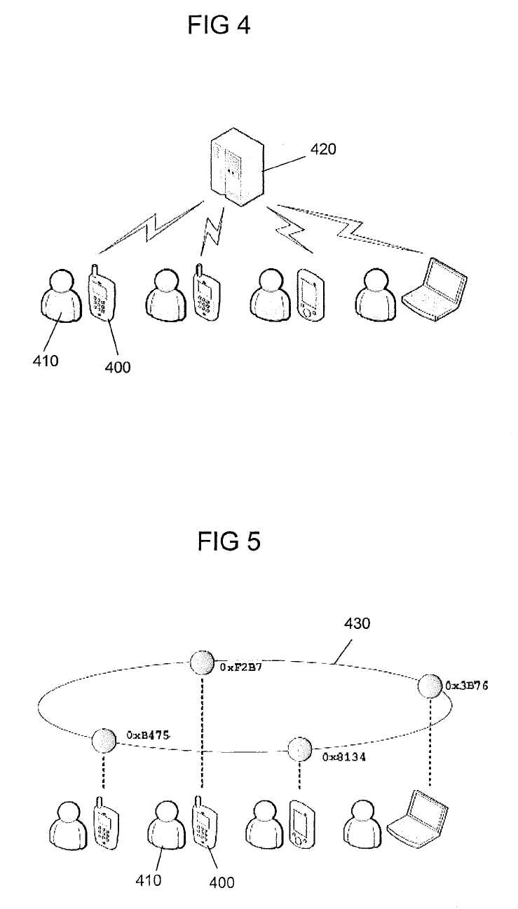

As already been explained, the application is applicable in combination with network architecture as well, which is based on a client/server architecture. Such architecture is illustrated in FIG. 4. A central server 420 is assigned in each case to the singular mobile terminals 400 of the singular user 410. The invention is also applicable in a network with peer-to-peer architecture, which is illustrated in FIG. 5. The singular terminals 410 are linked to a network 430 of computers which are equal and which use services as well as provide services. The singular mobile terminals thereby take on any tasks in the network.

The described invention allows a new kind of collaborative data handling and data processing as well as interaction between the users of mobile terminals. An advantage in contrast to conventional web-2.0-services is thereby the continuous availability of data and the application integration provided by the method according to the invention.

In the following, embodiments of the invention are described.

In an embodiment an update of contact information occurs. A user A has provided a user B with the code number for the user profile stored on its PDA. The user B adds the profile of the user A by entry of the code number to the address book on its mobile telephone. The user A authorises the access of the user B via a dialog on its PDS. The profile of the user A is now part of the address book of the user B. As soon as the user A changes a date of the profile (as for instance address or telephone number) this date is automatically updated in the address book of the mobile telephone of the user B. In case the mobile telephone of the user B is not switched on at the time in question or should not be connected to a network, then the date is updated as soon as the corresponding requirements are again provided.

In a further embodiment a matching of the calendar occurs. A user A has provided the user B with the code number for the calendar stored on its laptop. The user B adds the calendar to resources on its PDA by entry of the code number. The user A authorizes this process by adding user B to a group “work mates” for whom he has granted the corresponding rights. User B will be now informed as well as all of the other members of the group “work mates” by the user A on its PDA of current changes in the calendar of the user A.

A further embodiment relates to providing user specific current photos: The user A and B have connected their user profiles as in the two previous embodiments. User A takes now a picture with the camera of its mobile telephone (for instance of himself or a vacation destination) and adds this photo to its profile. This photo emerges now besides the entry of the user A in the address book of user B. Furthermore, the user B can adjust, when having a larger interest on the updates of user B, that these shall not only occur in the background but that in the display of its mobile telephone a dialog with its corresponding notification is shown during each update.

A further application example relates to status updates in dependency on the status of the terminal. The users A and B have connected their user profiles to each other as in the previous embodiments and allow furthermore access to the status information of their mobile phones. If user A now turns off the ring sound of his telephone (conference modus) then a labelling displaying this circumstance appears in the address book of the user B during its entry. If the user B does now want to call user A, then he sees that the user A is currently not available for phone calls and can postpone its phone call. In addition, the user B can adjust its mobile telephone such that it notifies him once by an acustic or visual note that the status of user A is again changed.

A further embodiment relates to distributed note pads. A user A can establish a note pad on its laptop and can grant a user B access on its PDA as described in the previous embodiments. If now the user A changes the content of the note pad (for instance a shopping list for the user B) then the changes are automatically changed in the note pad on the PDA of the user B. Furthermore, the user B can comment on the entries on the note pad of user A, what in turn is displayed automatically on the laptop of the user A.

The invention is not restricted in its embodiments to the previously described embodiments, which are solely to be understood as being exemplarily. For instance, the service adapter can consist of multiple software modules, which provide different tasks in the frame of the authentication and provision of the changed data sets to a PUSH service.

1.-23. (canceled)

21. A method for providing data on mobile terminals with the steps:
providing a continuous network connectivity of a plurality of mobile terminals of different users,
executing a local application on one of the terminals, which leads to a creation or a change of a data set,
automatically providing the created or changed data set to the other terminals, wherein
the created or changed data set is transmitted to the other terminals by the means of a PUSH service and
the created or change data set is transparently integrated into the corresponding local application on the other terminals.

22. The method according to claim 21, wherein the mobile terminals are continuously connected via a network, which comprises a client-server architecture.

23. The method according to claim 21, wherein the mobile terminals are connected continuously via a network, which comprises a Peer-to-Peer architecture.

24. The method according to claim 21, wherein the local application is a standard application of a mobile terminal, in particular an address book application, an appointment calendar application, a user profile, a note pad application, a photo album application, a multimedia application or general status determining information of the terminal.

25. The method according to claim 21, wherein an authentification occurs, which determines which data set are transmitted to which users and terminals.

26. The method according to claim 22, wherein an authentification occurs by means of centrally stored access control lists.

27. The method according to claim 23, wherein an authentification occurs between two users in each case immediately by using an additional encoding of the data sets, wherein especially only one user recognition is assigned in each case to the users and the encoding of the data set occurs by using of a key pair associated to the respective user recognition, wherein said key pair comprises in each case a private and a public key.

28. The method according to claim 27, wherein
the created or changed data set is encoded with its own symmetrical key,
the symmetrical key is encoded by the public key of the user who shall receive the data set, and
the encoded data set is deposited together with the encoded symmetrical key in the Peer-to-Peer network.

29. The method according to claim 27, wherein the owner of the data set signs the user recognition with its private key.

30. The method according to claim 29, wherein the signed user recognition is part of an identification data set, which is deposited in the Hash value of the user recognition in the peer-to-peer network, wherein especially the identification data set contains an additional information about the activity of the user and/or the current address of the mobile terminal used by said user.

31. The method according to claim 21, wherein the data set to be distributed are identified via a code number, wherein a code number characterizes each case a data set in its temporarily changeable form, wherein especially the code number contains the user recognition of the user of the data set.

32. The method according to claim 28, wherein the encoded data set is deposited together with the encoded symmetrical key in the Hash value of its code number in the peer-to-peer network.

33. The method according to claim 21, wherein the users of the mobile terminals are identified via code numbers.

34. The method according to claim 21, wherein the PUSH service is superimposed on the application interface of the operating system of the respective terminal.

35. The method according to claim 21, wherein the integration of a changed data set into a local application is displayed to the user of the mobile terminal.

36. The method according to claim 21, wherein the created or changed data set is again changed by the local application of a mobile terminal, which receives the data set and the again changed data set is transmitted back via a PUSH service to the mobile terminal, which created or changed the data set previously, and is again integrated into the application of this terminal.

37. A mobile terminal for executed a method according to claim 21, which comprises:
at least one local application and means for executing the local application, which provides a creation or a change of the data set,
a service adapter assigned to the application,
an authentification component in which access rights to the created or changed data set are deposited, wherein
the service adapter is formed and configured to
provide the user of the mobile terminal by using the authentification component the possibility to allow accession rights to the created or changed data set to other users of mobile terminals,
to transmit a created or changed data set by means of a PUSH service automatically to the terminals of other users, wherein the PUSH service provides the distribution of the data set by considering the data set deposited in the authentification components and the created or changed data set is transparently in the terminals of the other users into the corresponding local application,
and comprises furthermore means, which integrate transparently when receiving a created or changed data set of another device the created or changed data set into the corresponding own application.

38. The terminal according to claim 37, wherein the means, which when receiving a created or changed data set of another terminal transparently integrate the created or changed data set into the corresponding own application, are also provided by the service adapter.

39. The terminal according to claim 37, wherein the service adapter is designed and configured to provide the user of the mobile terminal via an expansion in the user interface of the application the possibility to allow other users of the communication network accession rights to the created or changed data sets.

40. A computer program with programming code for executing the method according to claim 21, if the computer program is executed on a computer.
